(19) United States
(12) Patent Application Publication
(10) Pub. No.: US 2004/0260596 A1
(43) Pub. Date: Dec. 23, 2004

(54) Service request system of sewing machine and method thereof

(76) Inventor: Jong-Soo Kim, Inchon (KR)

Correspondence Address: Galgano & Burke, Suite 135, 300 Rabro Drive, Hauppauge, NY, 11788, US

(21) Appl. No.: 10/824,660

(22) Filed: Apr. 14, 2004

(30) Foreign Application Priority Data
Apr. 21, 2003 (KR) 10-2003-0025221

(51) Int. Cl. G06F 17/60

(52) U.S. Cl. 705/9; 702/35

(57) ABSTRACT

Disclosed is a service request system of a sewing machine and a method thereof. The sewing machine or the embroidery machine applies manually or automatically to a service regional center for repair service through cable and wireless communication networks and the service regional center contacts with a service personnel nearest to the machine, in order to repair the machine, thereby being prompt to carry out the service. The method of requesting a fault service of the sewing machine comprises the steps of: transmitting a service request information through the cable and wireless communication networks, where the sewing machine is stopped by a fault; transmitting the received service request information to a terminal of a first service personnel nearest to the sewing machine in a service regional center; and transmitting a service processing particulars to the service regional center through the terminal of the first service personnel, after the fault service treatment is completed by the first service personnel.

### BACKGROUND OF THE INVENTION

Field of the Invention

The present invention relates to a service request system of a sewing machine and a method thereof. More particularly, the present invention relates to a service request system of an embroidery machine or a sewing machine and a method thereof in which the embroidery machine or the sewing machine applies manually or automatically to a service regional center for repair service through cable and wireless communication networks and the service regional center contacts with a service personnel nearest to the machine, in order to repair the machine, thereby being prompt to carry out the service.

In the service request system of the embroidery machine or the sewing machine and the method thereof according to the present invention, since the embroidery machine and the sewing machine are identical to each other in terms of the method of requesting the service and the sewing machine generally includes the embroidery machine, it will be mainly described around the embroidery machine hereinafter. Here, where the operation of the embroidery machine or the sewing machine is stopped by the fault thereof, since the method of diagnosing the fault is already well-known technique, it will be briefly described in the detailed description of the invention.

Generally, the embroidery machine or the sewing machine automatically embroiders a cloth according to an embroidery operation program. Accordingly, the embroidery system is provided with elements similar to a computer system.

FIG. 1 is a block diagram illustrating a construction of a conventional embroidery machine 10.

As shown in FIG. 1, the embroidery machine 10 includes an input unit 11 for inputting an embroidery design selection signal, and an operation start/stop signal of the embroidery machine 10 from an embroiderer, a storage 12 for storing a plurality of embroidery design files and an embroidery design program for allowing the embroidery machine to embroider a cloth by means of the embroidery design files, an embroidery operation unit 13 for embroidering the cloth in response to the signals inputted by the embroiderer through the input unit 11, a thread breakage detector 14 for detecting a upper-positioned thread breakage or an under-positioned thread exhausting during the operation of the embroidery machine 10, a display unit 15 for displaying the embroidery design files and the embroidery design program stored in the storage 12 so as to allow the embroiderer to select them, and displaying the detected contents of the thread breakage detector 14 and the embroidery working information, and a control unit 16 for controlling a whole operation of the embroidery machine 10 in response to the signals inputted by the embroiderer through the input unit 11.

The embroidery machine 10 constructed in this way is operated as follows.

Firstly, where the signal is inputted through the input unit 11 of the embroidery by the embroiderer, the embroidery design files stored in the storage 12 are displayed on the screen of the display unit 15. The embroiderer selects the desired embroiderer file among the plurality of embroidery design files displayed on the screen of the display unit 15 and then, inputs the embroidery start signal. At this time, by applying the selected embroidery design file to the embroidery design program, the control unit 16 controls the operation of the embroidery operation unit 13 for automatically embroidering the cloth. Accordingly, the embroidery operation unit 13 automatically embroiders the cloth according to the embroidery design stored in the embroidery design file by means of the control of the control unit 16.

In the meantime, where the upper-positioned thread is broken or the under-positioned thread is exhausted during the embroidery operation, the embroidery operation is stopped. At this time, the thread breakage detector 14 detects the upper-positioned thread breakage or an under-positioned thread exhausting and the detected content of the thread breakage detector 14 is displayed on the screen of the display unit 15. Accordingly, after the embroiderer checks the thread breakage message displayed on the screen of the display unit 15, the broken upper-positioned thread is connected or the exhausted under-positioned thread is exchanged by the embroiderer, so that the embroidery machine 10 can be normally operated.

However, in case that the conventional embroidery machine 10 is stopped by not the thread breakage fault, but other faults (for example, faults of other embroidery parts, such as a motor for driving a needle holder and so on), it is very difficulty for the embroiderer to find the cause of the fault of the embroidery machine. Also, the embroiderer cannot repair the embroidery machine 10, though he finds the cause of the fault.

Therefore, where the embroiderer cannot repair the embroidery machine 10, the embroiderer makes a phone call to a manager of service center in order to explain the fault condition of the machine 10 and request a repair service. The manager of service center communicates the fault condition to the visiting service personnel in order to repair the embroidery machine 10. Accordingly, after the visiting service personnel checks the fault condition from the manager of service center or makes a phone call to the embroiderer in order to check the fault condition, he visits the workshop to repair the embroidery machine.

However, there is a problem in that the embroiderer cannot request the repair service in case that the visiting service personnel vacates the seat or is in on a business trip.

Therefore, since it takes much time to repair the embroidery machine on account of the delay of the repair service, it can bring about an enormous difficulty in operating the embroidery machine.

### SUMMARY OF THE INVENTION

The present invention has been made to solve the foregoing problems and it is therefore an object of the present invention to provide a service request system of an embroidery machine and a method thereof in which the embroidery machine or the sewing machine applies manually or automatically to a service regional center for repair service through cable and wireless communication networks and the service regional center contacts with a service personnel nearest to the machine, in order to repair the machine, thereby being prompt to carry out the service.

It is another object of the present invention to provide a service request system of a sewing machine and a method thereof in which the embroidery machine or the sewing machine applies manually or automatically to a service regional center for repair service through cable and wireless communication networks and the service regional center contacts with a service personnel nearest to the machine, in order to repair the machine, thereby being prompt to carry out the service.

It is further another object of the present invention to provide a service request system of an embroidery machine or a sewing machine and a method thereof in which the operator applies to a service regional center for repair service through a PDA (Personal Digital Assistant) or a PC (Personal Computer) and the service regional center contacts with a service personnel nearest to the machine, in order to repair the machine, thereby being prompt to carry out the service.

In accordance with an embodiment of the present invention, there is provided a method of requesting a fault service of an embroidery machine or a sewing machine, comprising the steps of: transmitting a service request information through the cable and wireless communication networks, where any one of the embroidery machine and the sewing machine is stopped by a fault; transmitting the received service request information to a terminal of a first service personnel nearest to any one of the embroidery machine or the sewing machine in a service regional center; and transmitting a service processing particulars to the service regional center through the terminal of the first service personnel, after the fault service treatment is completed by the first service personnel.

In another embodiment, there is provided a method of requesting a fault service of an embroidery machine or a sewing machine, comprising the steps of: transmitting a service request information through cable and wireless communication networks, where any one of the embroidery machine and the sewing machine is stopped by a fault; transmitting a location information of service personnel to any one of the embroidery machine and the sewing machine in a service regional center which receives the service request information; searching and storing the location information of the service personnel received from the service regional center, and transmitting the service request information to a first service personnel terminal nearest to the machine in any one of the embroidery machine and the sewing machine; and transmitting a service processing particulars to the service regional center through the terminal of the first service personnel, after the fault service is completed by the first service personnel.

In further another embodiment, there is provided a method of requesting a fault service of an embroidery machine or a sewing machine, further comprising the steps of: detecting the cause of the fault by itself where any one of the embroidery machine and the sewing machine is stopped by the fault; displaying the detected cause of the fault on a screen of any one of the embroidery machine and the sewing machine; and automatically transmitting the service request information to the service regional center through the cable and wireless communication networks, where the cause of the stop of the machine corresponds to pre-setting fault items inputted to the machine in advance.

In further another embodiment, there is provided is provided a method of requesting a fault service of an embroidery machine or a sewing machine, further comprising the steps of: detecting the cause of the fault by itself where any one of the embroidery machine and the sewing machine is stopped by the fault; displaying the detected cause of the fault on a screen of any one of the embroidery machine and the sewing machine; and manually transmitting the service request information to the service regional center through the cable and wireless communication networks by an operator, according to the fault cause.

In further another embodiment, there is provided is provided a method of requesting a fault service of an embroidery machine or a sewing machine, further comprising the steps of: detecting a location information of any one of the embroidery machine and the sewing machine according to the service request information in the service regional center which receives the service request information; and detecting a location information of the first service personnel according to the location information received from the terminal of the first service personnel in the service regional center.

In further another embodiment, there is provided is provided a method of requesting a fault service of an embroidery machine or a sewing machine, further comprising the steps of: transmitting a message, in which a business trip on any one of the embroidery machine and the sewing machine is impossible, from the first service personnel to the service regional center; transmitting the service request information received from any one of the embroidery machine and the sewing machine to a second service personnel terminal nearer to any one of the embroidery machine and the sewing machine; and transmitting a service processing particulars to the service regional center through the terminal of the second service personnel, after the fault service is completed by the second service personnel.

In further another embodiment, there is provided is provided a method of requesting a fault service of an embroidery machine or a sewing machine, further comprising the steps of receiving the service request information of any one of the embroidery machine and the sewing machine and the service processing particulars of the first or second service personnel in an agency terminal.

In further another embodiment, there is provided is provided a method of requesting a fault service of an embroidery machine or a sewing machine, further comprising the steps of inquiring about and receiving an information including machine antecedents, embroidery-parts information of the machine, and manuals, next to connect the first or second service personnel terminal to any one of the service regional center and the agency terminal of the machine through the cable and wireless communication networks.

In the method, the service request information includes a machine information, a machine fault particulars, and a machine location information.

In further another embodiment, there is provided a service request system of an embroidery machine or a sewing machine comprising: an embroidery machine for transmitting a service request information through cable and wireless communication networks during its fault; a sewing machine for transmitting a service request information through cable and wireless communication networks during its fault; a service regional center for searching a location information of any one of the embroidery machine and the sewing machine by using the service request information received from any one of the embroidery machine and the sewing machine, detecting a location information of a service personnel from a location signal of a terminal of the service personnel, and transmitting the service request information to the terminal of the service personnel nearest to any one of the embroidery machine and the sewing machine; and the terminal of the service personnel for receiving the service request information from the service regional center and transmitting a location information thereof and a service processing particulars to the service regional center.

In further another embodiment, there is provided a service request system of an embroidery machine or a sewing machine comprising: an embroidery machine for transmitting a service request information through cable and wireless communication networks during its fault, receiving a location information of a service personnel from a service regional center, and transmitting the service request information to a terminal of the service personnel nearest to the embroidery machine; a sewing machine for transmitting a service request information through cable and wireless communication networks during its fault, receiving a location information of a service personnel from a service regional center, and transmitting the service request information to a terminal of the service personnel nearest to the sewing machine; a service regional center for receiving and detecting the location information of the service personnel from a location signal of the terminal of the service personnel and transmitting the location information of the service personnel to any one of the embroidery machine and the sewing machine, in response to the service request information received through the cable and wireless communication networks; and the terminal of the service personnel for receiving the service request information from any one of the embroidery machine and the sewing machine, and transmitting its location information and a service processing particulars to the service regional center.

In the service request system, the embroidery machine comprises: a storage for storing a plurality of embroidery design files and an embroidery design program; an input unit for inputting an embroidery design file selection signal and an operation start/stop signal of the embroidery machine from an operator; an embroidery operation unit for embroidering a cloth in response to the signals inputted by the operator through the input unit; an operating fault detector for detecting a cause of the fault of the embroidery machine; a display unit for displaying information including the location information of the service personnel, the fault information of the embroidery machine, and the embroidery design files and the embroidery design program stored in the storage on a screen thereof; a signal transmitting and receiving unit for transmitting and receiving data between the embroidery machine and any one of the service regional center and the terminal of the service personnel terminal through the cable and wireless communication networks; a service processing program storage for storing the service processing programs for processing the fault service; and a control unit for controlling a whole operation of the embroidery machine.

In the service request system, the sewing machine comprises: a storage for storing a plurality of sewing pattern files and a sewing pattern program; an input unit for inputting a sewing pattern file selection signal and an operation start/stop signal of the sewing machine from an operator; a sewing operation unit for sewing a cloth in response to the signals inputted by the operator through the input unit; an operating fault detector for detecting a cause of the fault of the sewing machine; a display unit for displaying information including the location information of the service personnel, the fault information of the sewing machine, and the sewing pattern files and the sewing pattern program stored in the storage on a screen thereof; a signal transmitting and receiving unit for transmitting and receiving data between the embroidery machine and any one of the service regional center and the terminal of the service personnel terminal through the cable and wireless communication networks; a service processing program storage for storing the service processing programs for processing the fault service; and a control unit for controlling a whole operation of the sewing machine.

In the service request system, the service processing program storage includes a service automatic processing program for automatically transmitting the service request information through the cable and wireless communication networks during the fault of any one of the embroidery machine and the sewing machine, and a service manual processing program for manually transmitting the service request information by the operator through the cable and wireless communication networks during the fault of any one of the embroidery machine and the sewing machine.

In the service request system, the service regional center comprises: a service accepting particulars management database for storing the service request information received from any one of the embroidery machine and the sewing machine; a service processing particulars management database for storing the service processing particulars received from the service personnel; a service personnel location information database for storing the location information of the service personnel; a machine antecedents management database for storing the machine antecedents information of any one of the embroidery machine and the sewing machine; a machinery-parts database for itemizing and storing the machine-parts information of any one of the embroidery machine and the sewing machine; a service information management database for storing a base service information of each nation of any one of the embroidery machine and the sewing machine; and a manual management database for storing a manual by a specification of any one of the embroidery machine and the sewing machine.

In the service request system, the service regional center comprises: a signal transmitting and receiving module for transmitting and receiving data to any one of the embroidery machine and sewing machine or the terminal of the service personnel; a service accepting and processing module for transmitting the service request information stored in the service accepting particulars management database to the terminal of the service personnel and storing the service processing particulars received from the terminal of the service personnel in the service processing particulars management database; a service personnel location information module for detecting the location information of the service personnel according to the location signal received from the terminal of the service personnel terminal and storing the location information in the service personnel location information database; and a information providing supporting module for transmitting the information stored in the databases to the service personnel terminal.

In the service request system, the terminal of the service personnel comprises: a signal transmitting and receiving unit for transmitting data between any one of the embroidery machine and the sewing machine and the service regional center through the cable and wireless communication networks; an input unit for inputting a signal for controlling an operation of the service personnel; a location signal generation unit for periodically generating the location information informing the present location of the service personnel; a ROM for storing the programs for operating and controlling the whole system of the service personnel terminal; a RAM for storing various information received from any one of the embroidery machine and the sewing machine and the service regional center; a display unit for displaying various information of any one of the embroidery machine and the sewing machine in response to the signal inputted by the service personnel through the input unit on the screen thereof; and a control processing unit for operating and controlling the whole system of the terminal of the service personnel.

In the service request system, the service request information includes a machine information, a machine fault particulars, and a machine location information.

In further another embodiment, there is provided a service request system of an embroidery machine or a sewing machine comprising: a terminal of an operator for transmitting a service request information through cable and wireless communication networks during a fault of any one of the embroidery machine and the sewing machine; a service regional center for searching a location information of any one of the embroidery machine and the sewing machine by using the service request information received from the terminal of the operator, detecting a location information of a service personnel from a location signal of a terminal of the service personnel, and transmitting the service request information to the terminal of the service personnel nearest to any one of the embroidery machine and the sewing machine; and the terminal of the service personnel for receiving the service request information from the service regional center and transmitting its location information and a service processing particulars to the service regional center.

In the service request system, the terminal of an operator is a wire data terminal, a wireless data terminal, PDA (Personal Digital Assistant) or a PC (Personal Computer).

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a construction of a conventional embroidery machine;

FIG. 2 shows a block diagram of a service request system of an embroidery machine according to the present invention;

FIG. 3 shows a block diagram of the embroidery machine according to the present invention;

FIG. 4 shows a block diagram of the service regional center according to the present invention;

FIG. 5 shows a block diagram of the service personnel terminal according to the present invention;

FIG. 6A to FIG. 6B are flow charts for explaining the method of requesting a fault service of an embroidery machine according to one embodiment of the present invention;

FIG. 7A to FIG. 7B are flow charts for explaining the method of requesting a fault service of an embroidery machine according to another embodiment of the present invention;

FIG. 8 shows a block diagram of a service request system of an overseas embroidery machine according to the present invention;

FIG. 9A to FIG. 9B are flow charts for explaining the method of requesting a fault service of the overseas embroidery machine;

FIG. 10A to FIG. 10B are flow charts for explaining the method of requesting a fault service of the overseas embroidery machine according to another embodiment of the present invention; and

FIG. 11 shows a block diagram of a service request system of an embroidery machine according to another embodiment of the present invention.

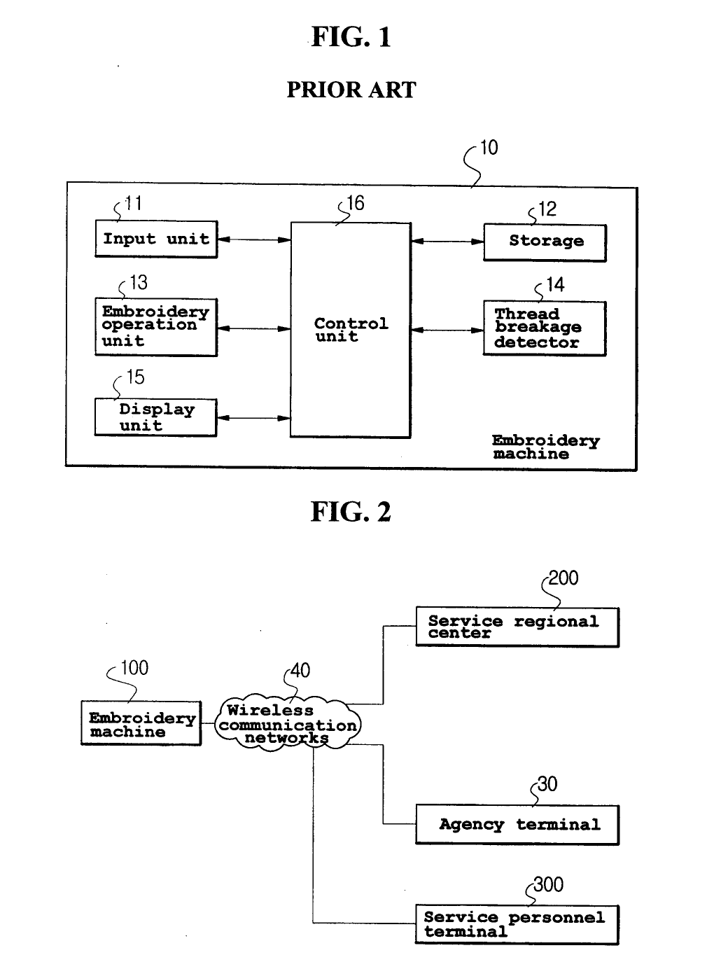

### DETAILED DESCRIPTION OF THE PREFERRED EMBODIMENT

A preferred embodiment of the invention will be described in detail below with reference to the accompanying drawings.

FIG. 2 shows a block diagram of a service request system of an embroidery machine 100 according to the present invention.

As shown in FIG. 2, the service request system of the domestic embroidery machine 100 (the embroidery machine installed in the country) includes the embroidery machine 100, a service regional center 200, a service personnel terminal 300, an agency terminal 30, and cable and wireless communication networks 40.

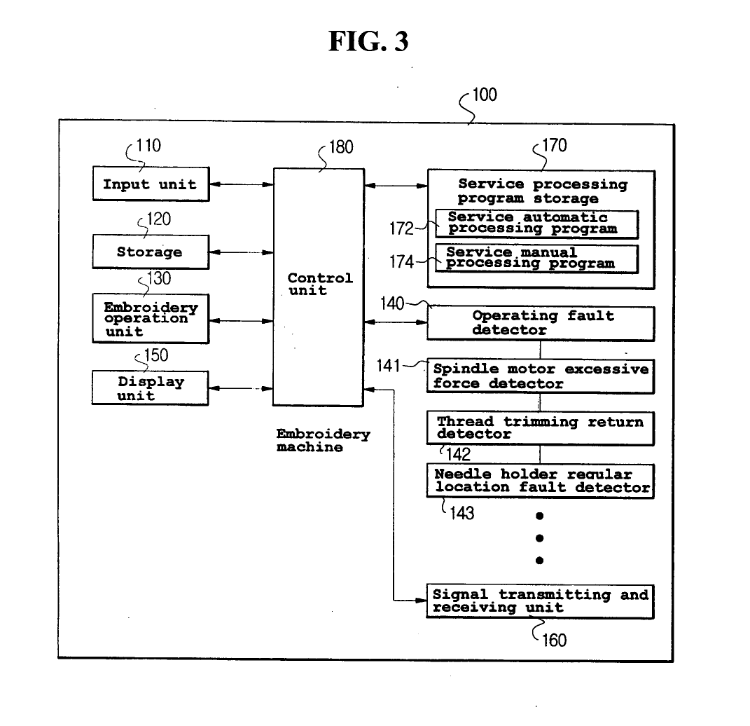

In the embroidery machine 100, where the embroidery operation is stopped by the fault, an operation fault detector 140 (note FIG. 3) searches the cause of the fault of the embroidery machine 100 and the searched result is displayed on a screen. At this time, in case that the cause of the fault of the embroider machine 100 corresponds to a pre-setting items (for example, a spindle motor excessive force fault, thread trimming system return fault, a needle holder regular position fault and so on), the service request signal, the machine information and the fault particulars are transmitted to the service regional center 200, an agency terminal 30, and the service personnel terminal 300 through the cable and wireless communication networks 40. Here, the pre-setting items mean the faults of the embroidery machine 100, which are not simply managed by the embroiderer, and are inputted to the machine in advance. Meanwhile, the under-positioned and the upper-positioned thread breakages, etc. can be simply managed by the embroiderer.

In the preceding descriptions, the embroidery machine 100 applies automatically to the service regional center for repair service through the cable and wireless communication networks after researching the cause of fault of the embroidery machine. However, in the present invention, where the embroidery operation is stopped by the fault, the embroiderer can manually request the fault service through the cable and wireless communication networks under his judgment.

The service regional center 200 receives the service request signal, the machine information and the fault particulars from the embroidery machine 100 and searches the position of the service personnel. Thereafter, the service regional center 200 transmits the service request signal, the machine information and the fault particulars to the service personnel terminal 300 nearest to the machine 100.

In the method of searching the location of the service personnel, the service regional center 200 can search the location of the service personnel terminal 300 by searching a moving location signal received from the service personnel terminal 300. Here, the moving location signal can be transmitted from the service personnel terminal 300 to the service regional center 200 by means of a GPS (Global Positioning System) or a CDMA (Code Division multiple access) communication network.

In another method of searching the location of the service personnel, the service regional center 200 can search the location of the service personnel terminal 300 by tracking the outgoing signals of the service personnel terminal 300 through a mobile communication companies.

In further another method of searching the location of the service personnel, the service regional center 200 can search the location of the service personnel terminal 300 by inputting and transmitting the present location of the service personnel at any time by means of his terminal 300.

The service personnel periodically transmits his moving location signal to the service regional center 200 and displays the service request signal of the embroidery machine 100, the machine information and the fault particulars, which are received from the service regional center 200, on the screen of his terminal 300. Also, the service personnel transmits the service management particulars to the service regional center 200.

The agency terminal 30 is a terminal of the business office which sells the embroidery machines 100. The agency terminal 30 provides embroidery-parts information of the embroidery machine 100 possessed in the agency to the service personnel terminal 300 in response to the request of the service personnel.

In the meantime, the embroidery machine 100, the service regional center 200 and a service personnel terminal 300 shown in FIG. 2 also, can be operated as follows.

In the embroidery machine 100, where the embroidery operation is stopped by the fault, an operation fault detector 140 (note FIG. 3) searches the cause of the fault of the embroidery machine 100 and the searched result is displayed on a screen. Here, the method of searching the cause of the fault by the operation fault detector 140 will be described in detail below with reference to FIG. 3. At this time, in case that the cause of the fault of the embroider machine 100 corresponds to the pre-setting items, the service request signal, the machine information and the fault particulars are transmitted to the service regional center 200, an agency terminal 30, and the service personnel terminal 300 through the cable and wireless communication networks 40. Thereafter, the service regional center 200 receives the service request signal, the machine information and the fault particulars from the embroidery machine 100 and searches the position of the service personnel. The service regional center 200 transmits the service request signal, the machine information and the fault particulars to the service personnel terminal 300 nearest to the machine 100.

In the preceding descriptions, the embroidery machine 100 applies automatically to the service regional center for repair service through the cable and wireless communication networks after researching the cause of fault of the embroidery machine. However, in the present invention, where the embroidery operation is stopped by the fault, the embroiderer can manually request the fault service through the cable and wireless communication networks under his judgment.

The service regional center 200 receives the service request signal from the embroidery machine 100 and transmits the location information of the service personnel terminal 300 to the machine 100 through the cable and wireless communication networks.

As stated above, the service regional center 200 can search the location of the service personnel terminal 300 by searching a moving location signal received from the service personnel terminal 300. Here, the moving location signal can be transmitted from the service personnel terminal 300 to the service regional center 200 by means of a GPS (Global Positioning System) or a CDMA (Code Division multiple access) communication network.

Also, the service regional center 200 can search the location of the service personnel terminal 300 by tracking the outgoing signals of the service personnel terminal 300 through a mobile communication companies.

Moreover, the service regional center 200 can search the location of the service personnel terminal 300 by inputting and transmitting the present location of the service personnel at any time by means of his terminal 300.

The service personnel periodically transmits his moving location signal to the service regional center 200 and displays the service request signal of the embroidery machine 100, the machine information and the fault particulars, which are received from the embroidery machine 100, on the screen of his terminal 300. Also, the service personnel transmits the service management particulars to the service regional center 200. The service personnel terminal 300 makes inquiry about embroidery-parts information of the embroidery machine 100 and receives the information from the service regional center 200 and the agency terminal 30.

FIG. 3 shows a block diagram of the embroidery machine 100 according to the present invention.

As shown in FIG. 3, the embroidery machine 100 includes an input unit 110, a storage 120, an embroidery operation unit 13, a operating fault detector 140 including a spindle motor excessive force detector 141, a thread trimming return detector 142, and a needle holder regular location fault detector 143, a display unit 150, a signal transmitting and receiving unit 160, a service processing program storage 170 including a service automatic processing program 172 and a service manual processing program 174, and a control unit 180.

The input unit 110 inputs an embroidery design selection signal and an operation start/stop signal of the embroidery machine 100 from an embroiderer.

The storage 120 stores a plurality of embroidery design files and an embroidery design program for allowing the embroidery machine 100 to embroider a cloth by means of the embroidery design files.

The embroidery operation unit 130 embroiders the cloth in response to the signals inputted by the embroiderer through the input unit 110.

The operating fault detector 140 detects the cause of the fault of embroidery machine 100, where the operation of the embroidery machine 100 is stopped by the fault. Since the detecting means of detecting the cause of the fault in the operating fault detector 140 are already widely known and various, only several detecting means will be described as stated below.

Firstly, the spindle motor excessive force detector 141 detects the excessive force of the spindle motor during the thread trimming. That is, if the thread trimming signal is inputted during the operation of the embroidery machine 100, the thread trimming operation is completed before the angle of the spindle turns to be 100 degrees. At this time, where the time to lead the angle of the spindle to 100 degrees is longer than the pre-setting time or the thread trimming operation is not stop from an angle of 100 degrees, the operating fault detector 140 detects the excessive force fault of the spindle motor and outputs the excessive force fault signal to the control unit 180.

The thread trimming return detector 142 includes a return sensor actuator of the thread trimming system at the thread trimming axis and a return detecting sensor (not shown) of the thread trimming system corresponding to it.

Accordingly, the return detecting sensor of the thread trimming system detects whether a moving mess linked to the thread trimming axis returns to the regular position or not. If the moving mess does not return to the regular position, the return detecting sensor outputs the detected content to the operating fault detector 140.

Then, the operating fault detector 140 transmits the return fault signal of the thread trimming system to the control unit 180 in response to the result detected by the return detecting sensor of the thread trimming system.

Also, the operating fault detector 140 can detect a spindle motor drive fault, an embroidery frame limit, a needle holder regular position fault, a spindle encoder A-phase fault, X-axis and Y-axis drive fault, a memory-related fault and so on.

It can check the existence of the fault according to the detecting sensor or the feedback values of the data.

The display unit 150 displays the embroidery design files and the embroidery design program stored in the storage 120 so as to allow the embroiderer to select them and displays the detected contents of the operating fault detector 140 and the embroidery working information. Also, The display unit 150 displays the location information of the service personnel received from the service regional center 200 on the screen thereof.

The signal transmitting and receiving unit 160 interfaces between the embroidery machine 100 or the embroiderer and the service regional center 200 or the service personnel terminal 300 through the cable and wireless communication networks 40, so as to transmit and receive the data between them.

The service processing program storage 170 stores the service processing programs for transmitting the service request signal, the machine information and the fault particulars to the service personnel terminal 300 nearest to the machine 100 through the cable and wireless communication networks 40, where the embroidery machine 100 is stopped by the fault and the cause of the fault of the embroider machine 100 corresponds to a pre-setting items.

The service processing program storage 170 includes the service automatic processing program 172 and the service manual processing program 174. By using the service automatic processing program 172, in case that the embroidery machine 100 is stopped by the fault and the cause of the fault of the embroider machine 100 corresponds to a pre-setting items, it searches the service personnel nearest to the machine 100 through the cable and wireless communication networks 40 and automatically transmits the service request signal, the machine information and the fault particulars to the terminal 300 of the searched service personnel. Meanwhile, where the embroidery machine 100 is stopped by the fault, the embroiderer checks the cause of the fault and decides whether it requests the fault service or not. At this time, if it is necessary to request the fault service, the embroiderer searches the service personnel nearest to the machine 100 through the cable and wireless communication networks 40 and manually transmits the service request signal, the machine information and the fault particulars to the terminal 300 of the searched service personnel by mean of the service manual processing program 174.

The control unit 160 controls a whole operation of the embroidery machine 100 in response to the signals inputted by the embroiderer through the input unit 110. That is, in case that the embroidery machine 100 is stopped by the fault, the control unit 16 controls the whole system of the embroidery machine 100, so that the location information of the service personnel received from the service regional center 200 is displayed on the screen of the display unit 150.

FIG. 4 shows a block diagram of the service regional center 200 according to the present invention.

As shown in FIG. 4, the service regional center 200 includes a signal transmitting and receiving module 210, a service accepting and processing module 220, a service personnel location information module 230, an information providing supporting module 240, a service accepting particulars management database 250, a service processing particulars management database 252, a service personnel location information database 254, a machine antecedents management database 256, machinery-parts database 258, a service information management database 260, and a manual management database 262.

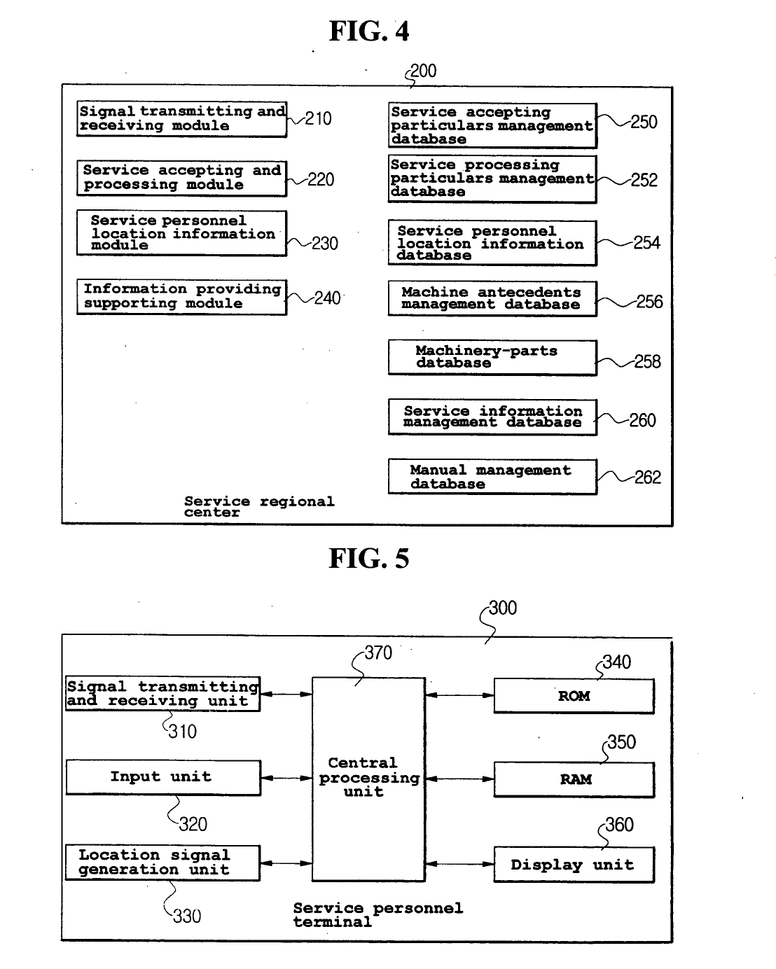

The signal transmitting and receiving module 210 interfaces between the signal transmitting and receiving unit 160 of embroidery machine 100 and a signal transmitting and receiving unit 310 (note FIG. 5) of the service personnel terminal 300 through the cable and wireless communication networks 40, so as to transmit and receive the data between them.

In the service accepting and processing module 220, the service personnel can make inquiry about the service accepting particulars stored in the service accepting particulars management database 250. The service accepting and processing module 220 stores the service processing particulars received from the service personnel in the service processing particulars management database 252, after completing the fault service.

The service personnel location information module 230 detects the location information of the service personnel terminal 300 according to the movement location signal received from the service personnel terminal 300, stores the location information in the a service personnel location information database 254, and transmits the location information to the embroidery machine 100 in response to the service request of the embroidery machine 100. Also, The service personnel location information module 230 transmits the service request signal, the machine information and the fault particulars received from the embroidery machine 100 to the service personnel terminal 300 nearest to the machine 100.

The information providing supporting module 240 transmits the embroidery machine antecedents information stored in the machine antecedents management database 256, the machinery-parts information stored in the machinery-parts database 258, the base service information of each nation stored in the service information management database 260, and the manual by the embroidery machine specification stored in the manual management database 262 to the service personnel terminal 300.

The service accepting particulars management database 250 stores the service accepting particulars, in order that the service personnel can make inquiry about the service accepting particulars.

The service processing particulars management database 252 stores the service processing particulars received from the service personnel, after completing the fault service.

The service personnel location information database 254 stores the location information of the service personnel terminal 300 detected by the service personnel location information module 230.

The machine antecedents management database 256 stores the machine antecedents information, in order that the service personnel can make inquiry about the machine antecedents information of the embroidery machine 100.

The machinery-parts database 258 itemizes and stores the embroidery-parts information.

The service information management database 260 stores the base service information of each nation.

The manual management database 262 stores the manual by the embroidery machine specification.

Accordingly, The service regional center 200 receives the service request signal, the machine information and the fault particulars from the embroidery machine 100 and searches the position of the service personnel. Thereafter, the service regional center 200 transmits the service request signal, the machine information and the fault particulars to the service personnel terminal 300 nearest to the machine 100. Also, the service regional center 200 transmits the location information of the service personnel in response to the service request signal received from the embroidery machine 100 to the embroidery machine 100. Moreover, the service regional center 200 transmits the machine antecedents information, the embroidery-parts information, the base service information of each nation and the manual by the embroidery machine specification to the service personnel terminal 300 in response to the request of the service personnel.

FIG. 5 shows a block diagram of the service personnel terminal 300 according to the present invention.

As shown in FIG. 5, the service personnel terminal 300 includes a signal transmitting and receiving unit 310, an input unit 320, a location signal generation unit 330, a ROM 340, a RAM 350, a display unit 360, and a central processing unit 370.

The signal transmitting and receiving unit 310 interfaces between the embroidery machine 100, the service regional center 200, a branch/corporation 20 or an agency terminal 30 through the cable and wireless communication networks 40, so as to transmit and receive the data each other.

The input unit 320 inputs a signal from the service personnel for checking the service request signal, the machine information and the fault particulars received from the machine 100 or the service regional center 200. Also, The input unit 320 inputs a signal for inquiring about the machine antecedents information, the embroidery-parts information, the base service information of each nation and the manual by the embroidery machine specification through the service regional center 200 and downloading the related information.

The location signal generation unit 330 periodically generates the moving location signal informing the present location of the service personnel terminal 300 and transmits it to the service regional center 200.

The ROM 340 stores the programs for operating and controlling the whole system of the service personnel terminal 300.

The RAM 350 stores the service request signal, the machine information and the fault particulars received from the embroidery machine 100 or the service regional center 200. Also, The RAM 350 stores the embroidery machine antecedents information, the machinery-parts information, the base service information of each nation, and the manual by the embroidery machine specification received from the service regional center 200. The RAM 350 may use all kinds of memories putted on the present market.

The display unit 360 displays the service request signal, the machine information and the fault particulars received from the embroidery machine 100 or the service regional center 200 in response to the signal inputted by the service personnel through the input unit 320 on the screen thereof. Also, The display unit 360 displays the embroidery machine antecedents information, the machinery-parts information, the base service information of each nation, and the manual by the embroidery machine specification received from the service regional center 200 on the screen thereof.

The control processing unit 370 operates and controls the whole system of the service personnel terminal 300.

Accordingly, the service personnel terminal 300 receives and stores the service request signal, the machine information and the fault particulars from the embroidery machine 100 or the service regional center 200 and displays them on its screen through the display unit 360. Also, the service personnel terminal 300 inquiries about the machine antecedents information, the embroidery-parts information, the base service information of each nation and the manual by the embroidery machine specification and stores the necessary information through a download. Moreover, the service personnel terminal 300 periodically generates the moving location signal informing the present location of the service personnel terminal 300 and transmits it to the service regional center 200.

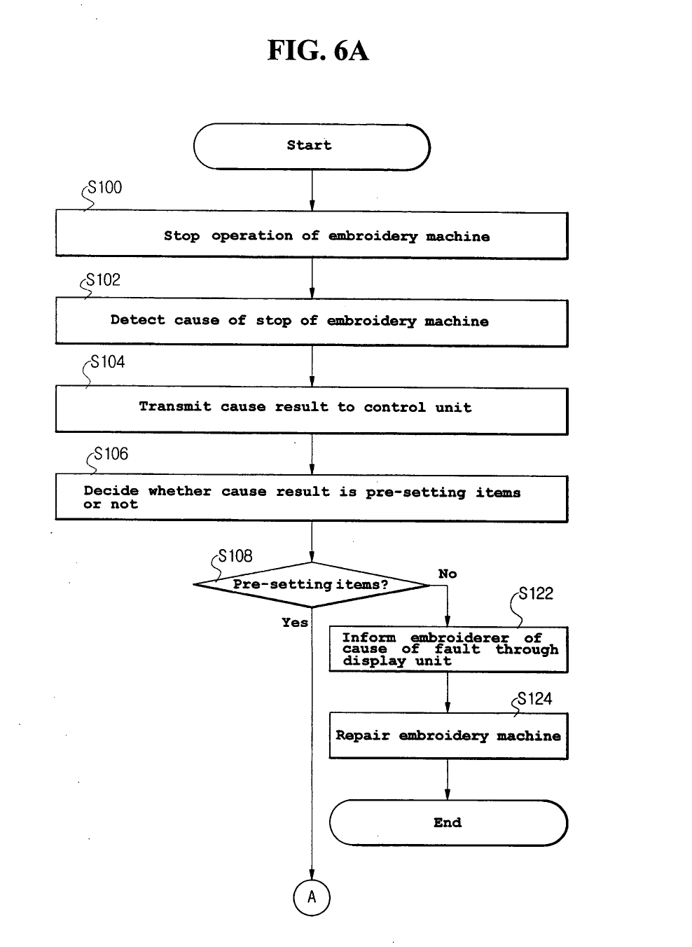

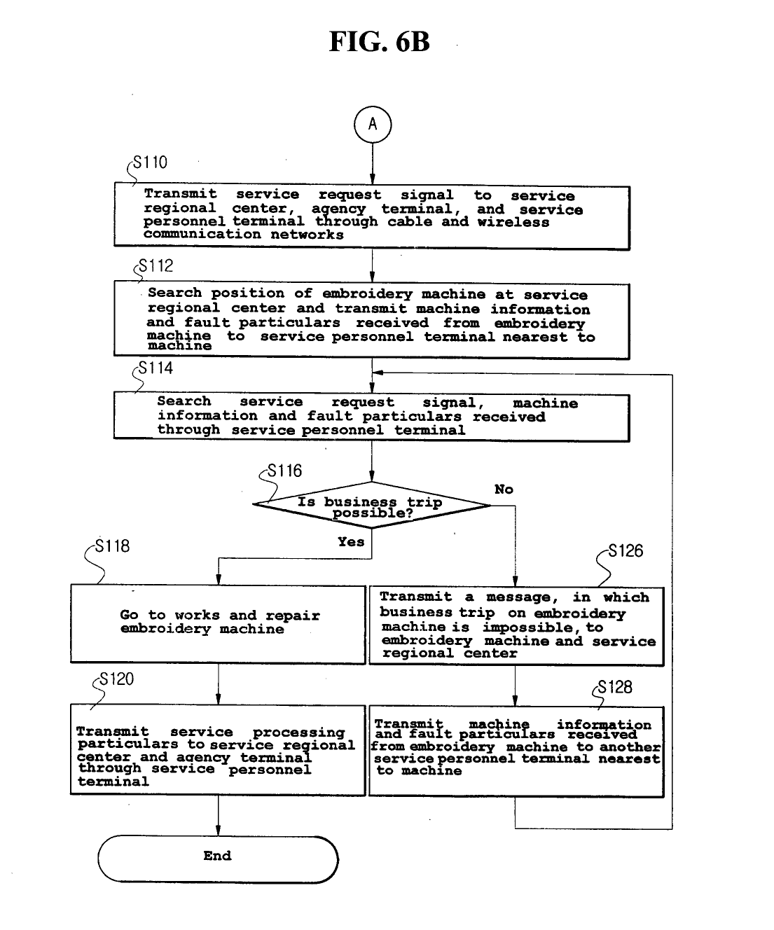

FIG. 6A to FIG. 6B are flow charts for explaining the method of requesting a fault service of an embroidery machine 100 according to one embodiment of the present invention. Here, in this embodiment of the present invention, the method of requesting a fault service of an embroidery machine 100 is operated by means of the service automatic processing program 172.

Where the embroidery machine 100 is stopped by the fault without the intention of the embroiderer, the operating fault detector 140 detects the cause of the stop of embroidery machine 100 and transmits the result to the control unit 180 (Steps S100 through S104).

The control unit 180 decides whether the cause of the stop of the embroidery machine 100 corresponds to the pre-setting items (Steps S106 through S108). At this time, if the cause of the stop of the embroidery machine 100 is not related to the pre-setting items (‘no’), the embroidery machine 100 informs the embroiderer of the cause of the fault through the display unit 150 so as to repair the embroidery machine 100 (Steps S122 through S124). Meanwhile, if the cause of the stop of the embroidery machine 100 corresponds to the pre-setting items (yes), the embroidery machine 100 transmits the service request signal to the service regional center 200, the agency terminal 30, and the service personnel terminal 300 through the cable and wireless communication networks 40 (Step 110).

The service regional center 200 receives the service request signal from the embroidery machine 100 and searches the position of the embroidery machine 100. Thereafter, the service regional center 200 transmits the machine information and the fault particulars received from the embroidery machine 100 to the service personnel terminal 300 nearest to the machine 100 (Step S112).

The service personnel searches the service request signal, the machine information and the fault particulars received from the embroidery machine 100 or the service regional center 200 through the service personnel terminal 300 (Step S114). Then, the service personnel decides whether the business trip on the embroidery machine 100 is possible or not (Step S116). At this time, where the business trip on the embroidery machine 100 is impossible, the service personnel transmits a message, in which the business trip on the embroidery machine 100 is impossible, to the embroidery machine 100 and the service regional center 200 (Step S126). In this case, the service regional center 200 transmits the machine information and the fault particulars received from the embroidery machine 100 to another service personnel terminal 300 nearest to the machine 100 (Step S128). The following step returns to the step 114.

In the meantime, in the step 116, where the business trip on the embroidery machine 100 is possible, the service personnel goes to the works and repairs the embroidery machine 100 (Step S118).

Finally, the service personnel transmits the service processing particulars to the service regional center 200 and the agency terminal 30 through the service personnel terminal 300 (Step S120).

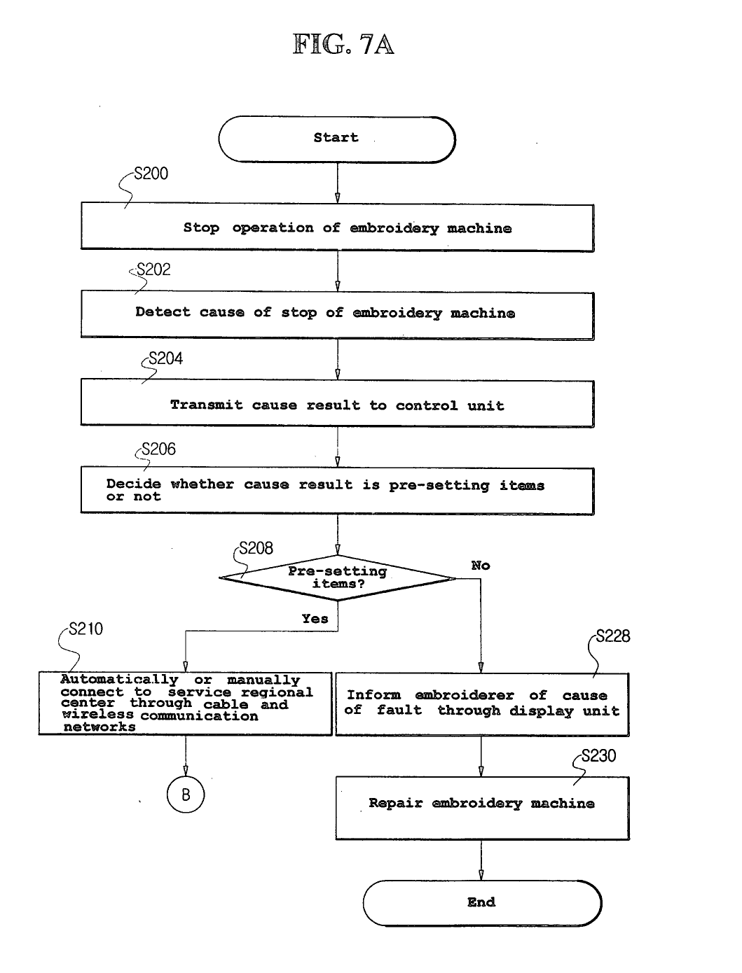

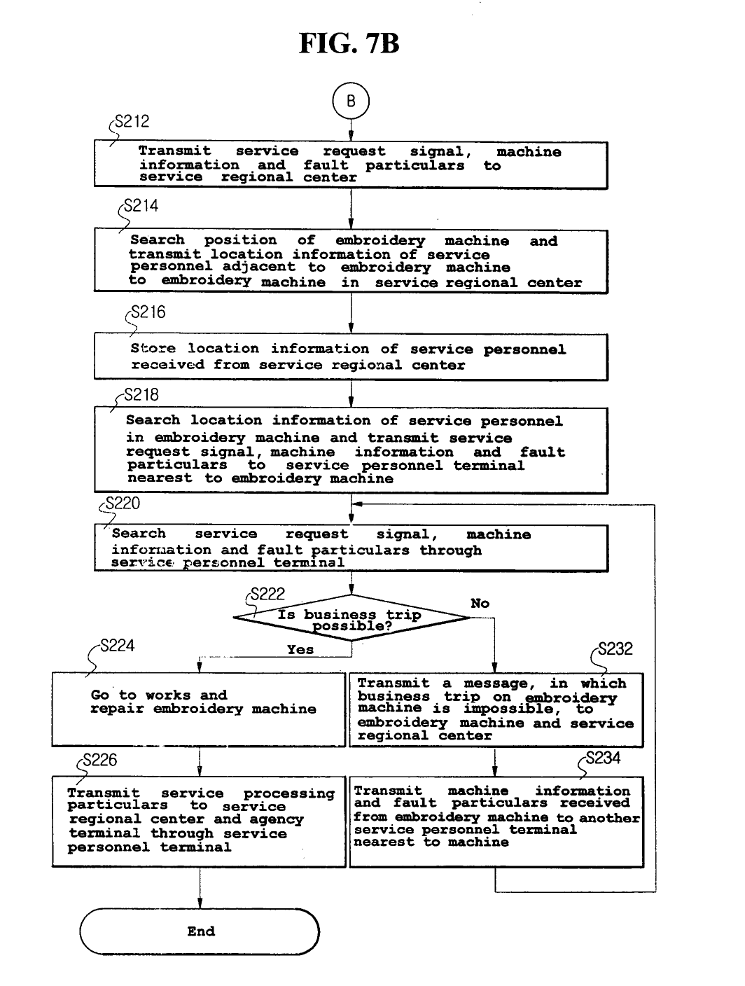

FIG. 7A to FIG. 7B are flow charts for explaining the method of requesting a fault service of an embroidery machine 100 according to another embodiment of the present invention.

Where the embroidery machine 100 is stopped by the fault without the intention of the embroiderer, the operating fault detector 140 detects the cause of the stop of embroidery machine 100 and transmits the result to the control unit 180 (Steps S200 through S204).

The control unit 180 decides whether the cause of the stop of the embroidery machine 100 corresponds to the pre-setting items (Steps S206 through S208). At this time, if the cause of the stop of the embroidery machine 100 is not related to the pre-setting items (‘no’), the embroidery machine 100 informs the embroiderer of the cause of the fault through the display unit 150 so as to repair the embroidery machine 100 (Steps S228 through S230). Meanwhile, if the cause of the stop of the embroidery machine 100 corresponds to the pre-setting items (yes), the embroidery machine 100 is automatically or manually on-line connected to the service regional center 200 through the cable and wireless communication networks 40 and transmits the service request signal, the machine information and the fault particulars to the service regional center 200 (Steps S210 through S212).

The service regional center 200 receives the service request signal from the embroidery machine 100 and searches the position of the embroidery machine 100. Thereafter, the service regional center 200 transmits the location information of the service personnel adjacent to the embroidery machine 100 to the embroidery machine 100 (Step S214).

The embroidery machine 100 stores the location information of the service personnel received from the service regional center 200 (Step S216). Thereafter, the embroidery machine 100 searches the location information of the service personnel and transmits the service request signal, the machine information and the fault particulars to the service personnel terminal 300 nearest to the embroidery machine 100 (Step S218).

The service personnel searches the service request signal, the machine information and the fault particulars through the service personnel terminal 300 (Step S220). Then, the service personnel checks whether the business trip on the embroidery machine 100 is possible or not (Step S222). At this time, where the business trip on the embroidery machine 100 is impossible, the service personnel transmits a message, in which the business trip on the embroidery machine 100 is impossible, to the embroidery machine 100 (Step S232). In this case, the embroidery machine 100 searches the location information of the service personnel and transmits the service request signal, the machine information and the fault particulars to another service personnel terminal 300 nearest to the machine 100 (Step S234). The following step returns to the step 220.

In the meantime, in the step 222, where the business trip on the embroidery machine 100 is possible, the service personnel goes to the works and repairs the embroidery machine 100 (Step S224).

Finally, the service personnel transmits the service processing particulars to the service regional center 200 through the service personnel terminal 300 (Step S226).

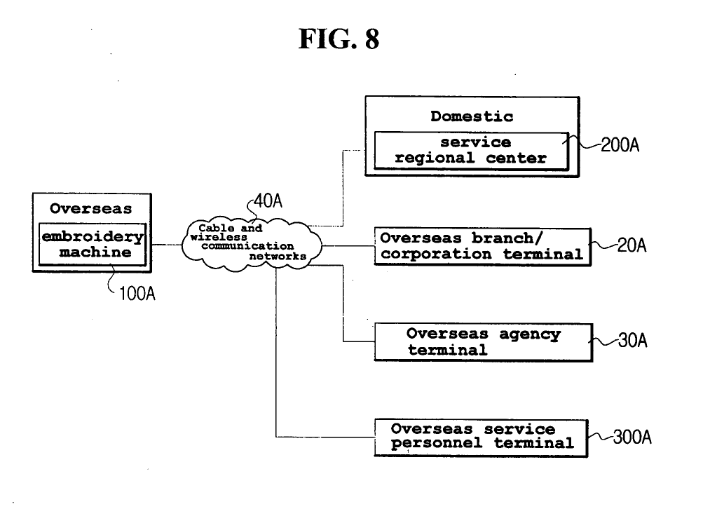

FIG. 8 shows a block diagram of a service request system of an overseas embroidery machine 100A according to the present invention.

As shown in FIG. 8, the service request system of the overseas embroidery machine 100A (the embroidery machine installed in foreign countries) includes the overseas embroidery machine 100A, a domestic service regional center 200A, an overseas service personnel terminal 300A, an overseas branch/corporation terminal 20A, an overseas agency terminal 30A, and cable and wireless communication networks 40A.

The overseas embroidery machine 100A, the domestic service regional center 200A, and the overseas service personnel terminal 300A are the same as the embroidery machine 100, the service regional center 200, and the service personnel terminal 300 as shown in FIG. 2 in terms of the construction and operation thereof. The service request systems as shown in FIG. 2 and FIG. 8 are merely different from each other in that the overseas embroidery machine 100A requests the service through the domestic service regional center 200A.

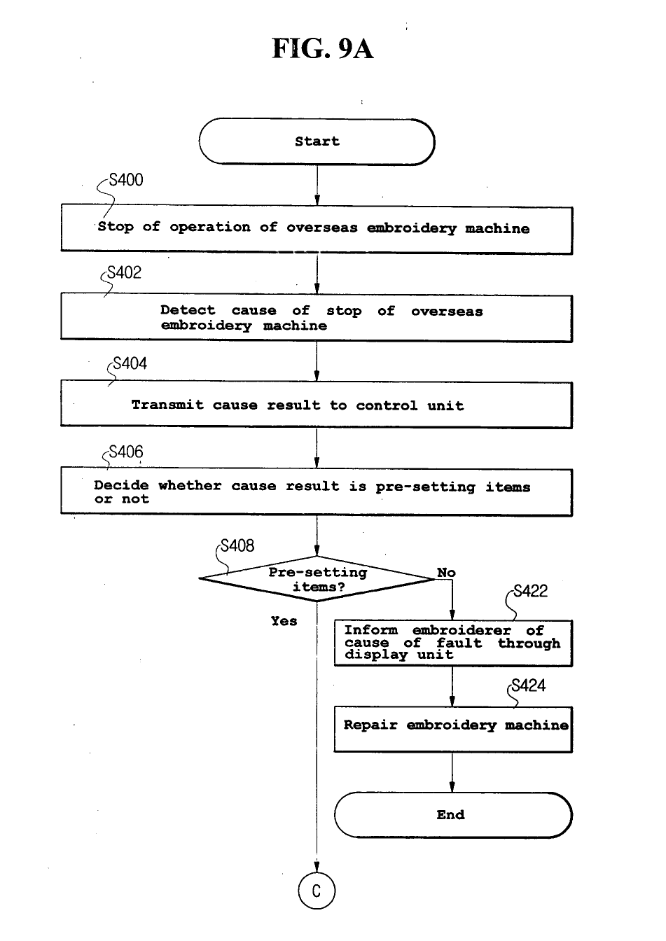

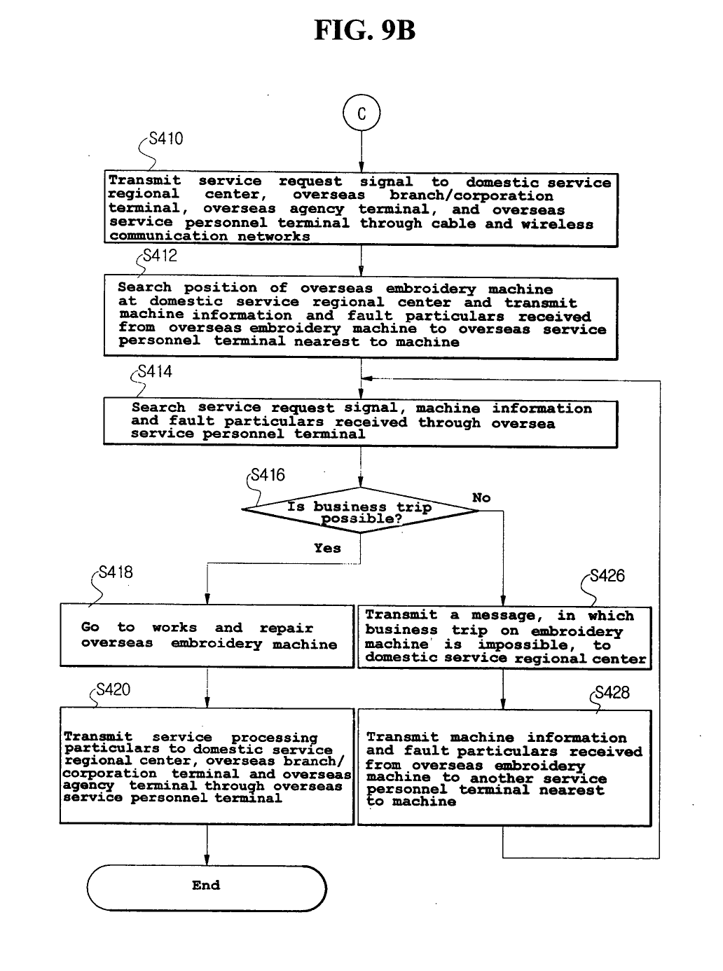

FIG. 9A to FIG. 9B are flow charts for explaining the method of requesting a fault service of the overseas embroidery machine 100A Where the overseas embroidery machine 100A is stopped by the fault without the intention of the embroiderer, the operating fault detector (not shown, the same as the reference numeral “140” in FIG. 3) detects the cause of the stop of the overseas embroidery machine 100A and transmits the result to the control unit (not shown, the same as the reference numeral “180” in FIG. 3) (Steps S400 through S404).

The control unit checks whether the cause of the stop of the overseas embroidery machine 100A corresponds to the pre-setting items (Steps S406 through S408). At this time, if the cause of the stop of the overseas embroidery machine 100A is not related to the pre-setting items (‘no’), the overseas embroidery machine 100A informs the embroiderer of the cause of the fault through the display unit (not shown, the same as the reference numeral “150” in FIG. 3) so as to repair the overseas embroidery machine 100A (Steps S422 through S424). Meanwhile, if the cause of the stop of the overseas embroidery machine 100A corresponds to the pre-setting items (yes), the overseas embroidery machine 100A transmits the service request signal to the domestic service regional center 200A, the overseas branch/corporation terminal 20A, the overseas agency terminal 30A, and the overseas service personnel terminal 300A through the cable and wireless communication networks 40A (Step 410).

The domestic service regional center 200A receives the service request signal from the overseas embroidery machine 100A and searches the position of the overseas embroidery machine 100A. Thereafter, the overseas service regional center 200A transmits the machine information and the fault particulars received from the overseas embroidery machine 100A to the overseas service personnel terminal 300 nearest to the overseas embroidery machine 100A (Step S412).

The overseas service personnel searches the service request signal, the machine information and the fault particulars received through the overseas service personnel terminal 300A (Step S414). Then, the overseas service personnel checks whether the business trip on the overseas embroidery machine 100A is possible or not (Step S416). At this time, where the business trip on the overseas embroidery machine 100A is impossible, the overseas service personnel transmits a message, in which the business trip on the overseas embroidery machine 100A is impossible, to the embroidery machine 100A and the domestic service regional center 200A (Step S426). In this case, the domestic service regional center 200A transmits the machine information and the fault particulars received from the oversea embroidery machine 100A to another service personnel terminal 300A nearest to the machine 100A (Step S428). The following step returns to the step 414.

In the meantime, in the step 416, where the business trip on the overseas embroidery machine 100A is possible, the service personnel goes to the works and repairs the embroidery machine 100A (Step S418).

Finally, the service personnel transmits the service processing particulars to the domestic service regional center 200A, the overseas branch/corporation terminal 20A, and the overseas agency terminal 30A through the overseas service personnel terminal 300A (Step S420).

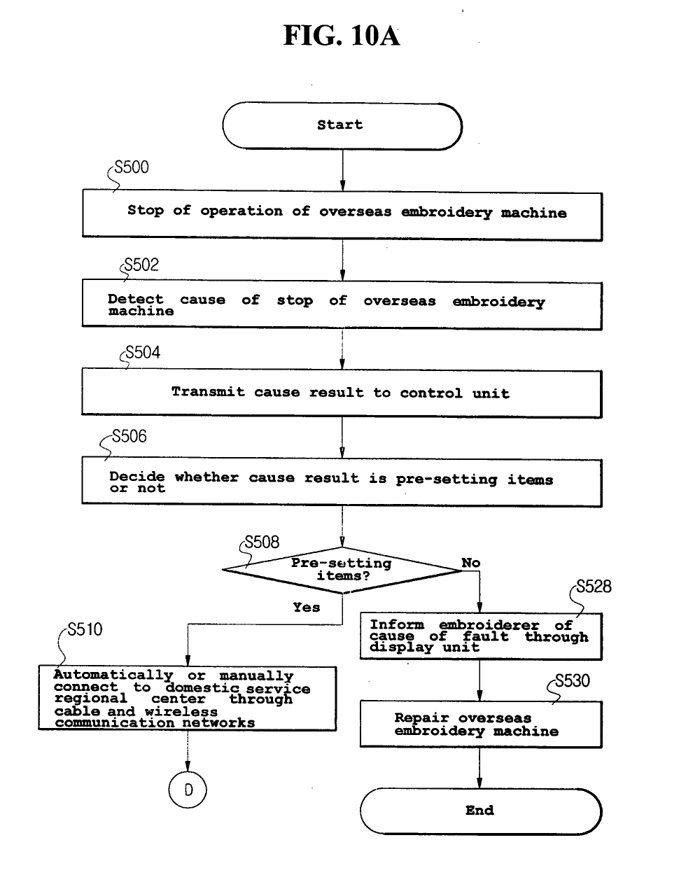

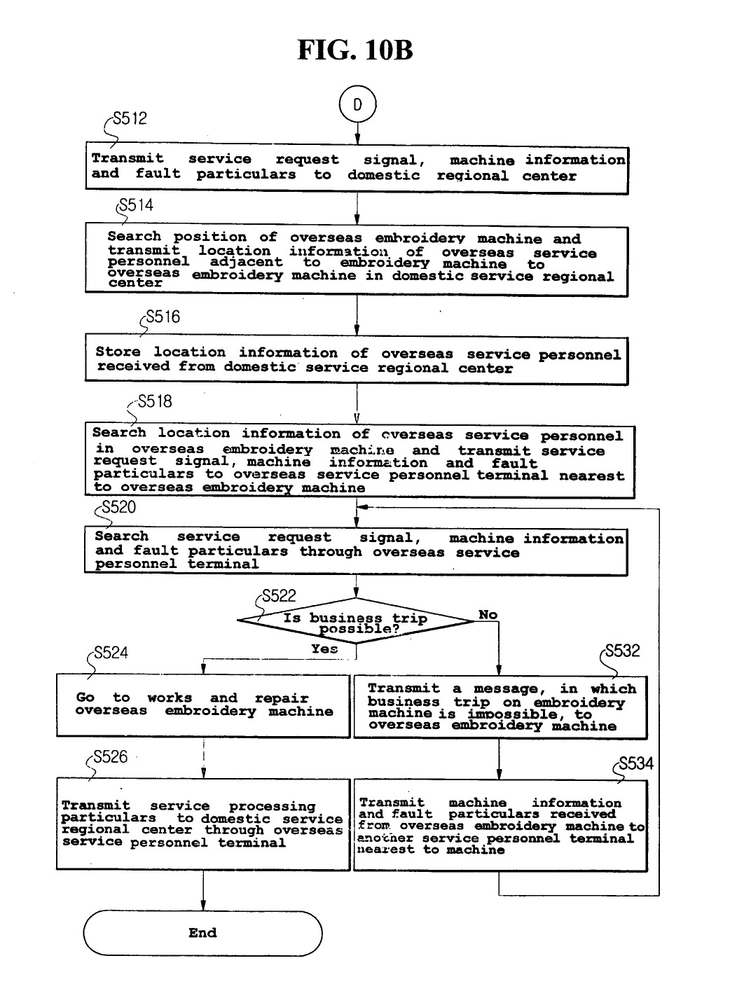

FIG. 10A to FIG. 10B are flow charts for explaining the method of requesting a fault service of the overseas embroidery machine 100A according to another embodiment of the present invention.

Where the overseas embroidery machine 100A is stopped by the fault without the intention of the embroiderer, the operating fault detector (not shown, the same as the reference numeral “140” in FIG. 3) detects the cause of the stop of overseas embroidery machine 100A and transmits the result to the control unit (not shown, the same as the reference numeral “180” in FIG. 3) (Steps S500 through S504).

The control unit checks whether the cause of the stop of the overseas embroidery machine 100A corresponds to the pre-setting items (Steps S506 through S508). At this time, if the cause of the stop of the overseas embroidery machine 100A is not related to the pre-setting items (‘no’), the overseas embroidery machine 100A informs the embroiderer of the cause of the fault through the display unit (not shown, the same as the reference numeral “150” in FIG. 3) so as to repair the embroidery machine 100A (Steps S528 through S530). Meanwhile, if the cause of the stop of the overseas embroidery machine 100A corresponds to the pre-setting items (yes), the overseas embroidery machine 100A is automatically or manually on-line connected to the domestic service regional center 200A through the cable and wireless communication networks 40A and transmits the service request signal, the machine information and the fault particulars to the domestic service regional center 200A (Steps S510 through S512).

The domestic service regional center 200A receives the service request signal from the overseas embroidery machine 100A and searches the position of the overseas embroidery machine 100A. Thereafter, the domestic service regional center 200A transmits the location information of the service personnel adjacent to the overseas embroidery machine 100A to the overseas embroidery machine 100A (Step S514).

The overseas embroidery machine 100A stores the location information of the service personnel received from the domestic service regional center 200A (Step S516): Thereafter, the overseas embroidery machine 100A searches the location information of the overseas service personnel and transmits the service request signal, the machine information and the fault particulars to the overseas service personnel terminal 300A nearest to the overseas embroidery machine 100A (Step S518).

The overseas service personnel searches the service request signal, the machine information and the fault particulars through the overseas service personnel terminal 300A (Step S520). Then, the overseas service personnel checks whether the business trip on the overseas embroidery machine 100A is possible or not (Step S522). At this time, where the business trip on the overseas embroidery machine 100A is impossible, the overseas service personnel transmits a message, in which the business trip on the overseas embroidery machine 100A is impossible, to the overseas embroidery machine 100A (Step S532). In this case, the overseas embroidery machine 100A searches the location information of the overseas service personnel and transmits the service request signal, the machine information and the fault particulars to another service personnel terminal 300A nearest to the overseas embroidery machine 100A (Step S534). The following step returns to the step 520.

In the meantime, in the step 522, where the business trip on the overseas embroidery machine 100A is possible, the service personnel goes to the works and repairs the overseas embroidery machine 100A (Step S524).

Finally, the overseas service personnel transmits the service processing particulars to the domestic service regional center 200A through the overseas service personnel terminal 300A (Step S526).

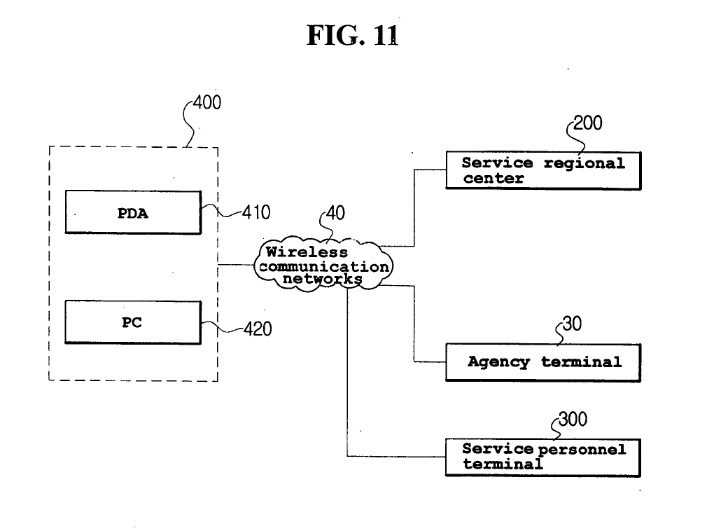

FIG. 11 shows a block diagram of a service request system of an embroidery machine according to another embodiment of the present invention.

As shown in FIG. 11, the service request system of the embroidery machine includes a service regional center 200, a service personnel terminal 300, an agency terminal 30, cable and wireless communication networks 40, and an embroidery machine or a sewing machine (not shown).

In the embroidery machine, where the embroidery operation is stopped by the fault, the operation fault detector 140 (note FIG. 3) searches the cause of the fault of the embroidery machine and the searched result is displayed on a screen. At this time, in case that the cause of the fault of the embroider machine 100 corresponds to a pre-setting items (for example, a spindle motor excessive force fault, thread trimming system return fault, a needle holder regular position fault and so on) or other causes excepting for that, or the embroiderer decides to request the fault service according to the fault causes, the service request signal, the machine information and the fault particulars are transmitted to the service regional center 200, an agency terminal 30, and the service personnel terminal 300 by using a wire data terminal, a wireless data terminal, a PDA (Personal Digital Assistant) 410 or a PC 420. Here, the pre-setting items mean the faults of the embroidery machine, which are not simply managed by the embroiderer, and are inputted to the machine in advance. Meanwhile, the under-positioned and the upper-positioned thread breakages, etc. can be simply managed by the embroiderer.

In the preceding descriptions, the cause of the embroidery machine is detected by the operation fault detector 140. However, where the embroidery machine is not provided with the operation fault detector 140, if it is necessary to request the fault service, the embroiderer can request the fault service by using the PDA (Personal Digital Assistant) 410 or the PC (Personal Computer) 420.

The service regional center 200 receives the service request signal, the machine information and the fault particulars from the embroidery machine and searches the position of the service personnel. Thereafter, the service regional center 200 transmits the service request signal, the machine information and the fault particulars received from the embroidery machine to the service personnel terminal 300 nearest to the machine.

In the method of searching the location of the service personnel, the service regional center 200 can search the location of the service personnel terminal 300 by searching a moving location signal received from the service personnel terminal 300. Here, the moving location signal can be transmitted from the service personnel terminal 300 to the service regional center 200 by means of a GPS (Global Positioning System) or a CDMA (Code Division multiple access) communication network.

In another method of searching the location of the service personnel, the service regional center 200 can search the location of the service personnel terminal 300 by tracking the outgoing signals of the service personnel terminal 300 through a mobile communication companies.

In further another method of searching the location of the service personnel, the service regional center 200 can search the location of the service personnel terminal 300 by inputting and transmitting the present location of the service personnel at any time by means of his terminal 300.

The service personnel periodically transmits his moving location signal to the service regional center 200 and displays the service request signal of the embroidery machine, the machine information and the fault particulars, which are received from the service regional center 200, on the screen of his terminal 300. Also, the service personnel transmits the service management particulars to the service regional center 200.

The agency terminal 30 is a terminal of the business office which produce and sells the embroidery machines 100. The agency terminal 30 provides embroidery-parts information of the embroidery machine 100 possessed in the agency to the service personnel terminal 300 in response to the request of the service personnel.

The service personnel terminal includes the PDA (Personal Digital Assistant) 410 or the PC 420.

Also, the service request system can apply to the sewing machine instead of the embroidery machine in the same way.

As clearly discussed above, according to the service request system of an embroidery machine or the sewing machine and a method thereof of the present invention, the request system of the embroidery the embroidery machine or the sewing machine applies manually or automatically to a service regional center for repair service through cable and wireless communication networks and the service regional center contacts with a service personnel nearest to the machine, in order to repair the machine, thereby being prompt to carry out the service.

Also, the domestic service regional center can easily check the present condition of the fault service in each nation, so that its management is very easy.

This disclosure provides exemplary embodiments of the present invention. The scope of the present invention is not limited by these exemplary embodiments. Numerous variations, whether explicitly provided for or implied by the specification, such as variations in structure, dimension, type of material and the manufacturing process may be implemented by one who is skilled in the art, in view of this disclosure

What is claimed is:

1. A method of requesting a fault service of a sewing machine, comprising the steps of:
transmitting a service request information through the cable and wireless communication networks, where the sewing machine is stopped by a fault;
transmitting the received service request information to a terminal of a first service personnel nearest to the sewing machine in a service regional center; and
transmitting a service processing particulars to the service regional center through the terminal of the first service personnel, after the fault service treatment is completed by the first service personnel.

2. A method of requesting a fault service of a sewing machine, comprising the steps of:
transmitting a service request information through cable and wireless communication networks, where the sewing machine is stopped by a fault;
transmitting a location information of service personnel to the sewing machine in a service regional center which receives the service request information;
searching and storing the location information of the service personnel received from the service regional center, and transmitting the service request information to a first service personnel terminal nearest to the machine in the sewing machine; and
transmitting a service processing particulars to the service regional center through the terminal of the first service personnel, after the fault service is completed by the first service personnel.

3. The method as claimed in claim 1, further comprising the steps of:
detecting the cause of the fault by itself where the sewing machine is stopped by the fault;
displaying the detected cause of the fault on a screen of the sewing machine; and
automatically transmitting the service request information to the service regional center through the cable and wireless communication networks, where the cause of the stop of the machine corresponds to pre-setting fault items inputted to the machine in advance.

4. The method as claimed in claim 1, further comprising the steps of:
detecting the cause of the fault by itself where the sewing machine is stopped by the fault;
displaying the detected cause of the fault on a screen of the sewing machine; and
manually transmitting the service request information to the service regional center through the cable and wireless communication networks by an operator, according to the fault cause.

5. The method as claimed in claim 1, further comprising the steps of:
detecting a location information of the sewing machine according to the service request information in the service regional center which receives the service request information; and
detecting a location information of the first service personnel according to the location information received from the terminal of the first service personnel in the service regional center.

6. The method as claimed in claim 1, further comprising the steps of:
transmitting a message, in which a business trip on the sewing machine is impossible, from the first service personnel to the service regional center;
transmitting the service request information received from the sewing machine to a second service personnel terminal nearer to the sewing machine; and
transmitting a service processing particulars to the service regional center through the terminal of the second service personnel, after the fault service is completed by the second service personnel.

7. The method as claimed in claim 6, further comprising the steps of receiving the service request information of the sewing machine and the service processing particulars of the first or second service personnel in an agency terminal.

8. The method as claimed in claim 7, further comprising the steps of inquiring about and receiving an information including machine antecedents, embroidery-parts information of the machine, and manuals, next to connect the first or second service personnel terminal to any one of the service regional center and the agency terminal of the machine through the cable and wireless communication networks.

9. The method as claimed in claim 1, wherein the service request information includes a machine information, a machine fault particulars, and a machine location information.

10. A service request system of a sewing machine comprising:
a sewing machine for transmitting a service request information through cable and wireless communication networks during its fault;
a service regional center for searching a location information of the sewing machine by using the service request information received from the sewing machine, detecting a location information of a service personnel from a location signal of a terminal of the service personnel, and transmitting the service request information to the terminal of the service personnel nearest to the sewing machine; and
the terminal of the service personnel for receiving the service request information from the service regional center and transmitting a location information thereof and a service processing particulars to the service regional center.

11. A service request system of a sewing machine comprising:
a sewing machine for transmitting a service request information through cable and wireless communication networks during its fault, receiving a location information of a service personnel from a service regional center, and transmitting the service request information to a terminal of the service personnel nearest to the sewing machine;
a service regional center for receiving and detecting the location information of the service personnel from a location signal of the terminal of the service personnel and transmitting the location information of the service personnel to the sewing machine, in response to the service request information received through the cable and wireless communication networks; and
the terminal of the service personnel for receiving the service request information from the sewing machine, and transmitting its location information and a service processing particulars to the service regional center.

12. The service request system as claimed in claim 10, wherein the sewing machine comprises:
a storage for storing a plurality of embroidery design files and an embroidery design program;
an input unit for inputting an embroidery design file selection signal and an operation start/stop signal of the sewing machine from an operator;
an embroidery operation unit for embroidering a cloth in response to the signals inputted by the operator through the input unit;
an operating fault detector for detecting a cause of the fault of the sewing machine;
a display unit for displaying information including the location information of the service personnel, the fault information of the embroidery machine, and the embroidery design files and the embroidery design program stored in the storage on a screen thereof;
a signal transmitting and receiving unit for transmitting and receiving data between the sewing machine and any one of the service regional center and the terminal of the service personnel terminal through the cable and wireless communication networks;
a service processing program storage for storing the service processing programs for processing the fault service; and
a control unit for controlling a whole operation of the sewing machine.

13. The service request system as claimed in claim 10, wherein the sewing machine comprises:
a storage for storing a plurality of sewing pattern files and a sewing pattern program;
an input unit for inputting a sewing pattern file selection signal and an operation start/stop signal of the sewing machine from an operator;
a sewing operation unit for sewing a cloth in response to the signals inputted by the operator through the input unit;
an operating fault detector for detecting a cause of the fault of the sewing machine;
a display unit for displaying information including the location information of the service personnel, the fault information of the sewing machine, and the sewing pattern files and the sewing pattern program stored in the storage on a screen thereof;
a signal transmitting and receiving unit for transmitting and receiving data between the sewing machine and any one of the service regional center and the terminal of the service personnel terminal through the cable and wireless communication networks;
a service processing program storage for storing the service processing programs for processing the fault service; and
a control unit for controlling a whole operation of the sewing machine.

14. The service request system as claimed in claim 12, wherein the service processing program storage includes a service automatic processing program for automatically transmitting the service request information through the cable and wireless communication networks during the fault of the sewing machine, and a service manual processing program for manually transmitting the service request information by the operator through the cable and wireless communication networks during the fault of the sewing machine.

15. The service request system as claimed in claim 10, wherein the service regional center comprises:
a service accepting particulars management database for storing the service request information received from the sewing machine;
a service processing particulars management database for storing the service processing particulars received from the service personnel;
a service personnel location information database for storing the location information of the service personnel;
a machine antecedents management database for storing the machine antecedents information of the sewing machine;
a machinery-parts database for itemizing and storing the machine-parts information of the sewing machine;
a service information management database for storing a base service information of each nation of the sewing machine; and
a manual management database for storing a manual by a specification of the sewing machine.

16. The service request system as claimed in claim 15, wherein the service regional center comprises:
a signal transmitting and receiving module for transmitting and receiving data to the sewing machine or the terminal of the service personnel;
a service accepting and processing module for transmitting the service request information stored in the service accepting particulars management database to the terminal of the service personnel and storing the service processing particulars received from the terminal of the service personnel in the service processing particulars management database;
a service personnel location information module for detecting the location information of the service personnel according to the location signal received from the terminal of the service personnel terminal and storing the location information in the service personnel location information database; and
an information providing supporting module for transmitting the information stored in the databases to the service personnel terminal.

17. The service request system as claimed in claim 10, wherein the terminal of the service personnel comprises:
a signal transmitting and receiving unit for transmitting data between the sewing machine and the service regional center through the cable and wireless communication networks;
an input unit for inputting a signal for controlling an operation of the service personnel;
a location signal generation unit for periodically generating the location information informing the present location of the service personnel;
a ROM for storing the programs for operating and controlling the whole system of the service personnel terminal;
a RAM for storing various information received from the sewing machine and the service regional center;
a display unit for displaying various information of the sewing machine in response to the signal inputted by the service personnel through the input unit on the screen thereof; and
a control processing unit for operating and controlling the whole system of the terminal of the service personnel.

18. The service request system as claimed in claim 10, wherein the service request information includes a machine information, a machine fault particulars, and a machine location information.

19. A service request system of a sewing machine comprising:
a terminal of an operator for transmitting a service request information through cable and wireless communication networks during a fault of the sewing machine;
a service regional center for searching a location information of the sewing machine by using the service request information received from the terminal of the operator, detecting a location information of a service personnel from a location signal of a terminal of the service personnel, and transmitting the service request information to the terminal of the service personnel nearest to the sewing machine; and
the terminal of the service personnel for receiving the service request information from the service regional center and transmitting its location information and a service processing particulars to the service regional center.

20. The service request system as claimed in claim 19, wherein the terminal of an operator is a wire data terminal, a wireless data terminal, a PDA (Personal Digital Assistant) or a PC (Personal Computer).
